(19) United States
(12) Patent Application Publication
(10) Pub. No.: US 2013/0248004 A1
(43) Pub. Date: Sep. 26, 2013

(54) Methods and Systems for Restraining a Flow Line

(71) Applicant: S.P.M. FLOW CONTROL, INC., Fort Worth, TX (US)

(72) Inventors: Jacob A. Money, Searcy, AR (US); Robert Gary Moore, San Antonio, TX (US)

(73) Assignee: S.P.M. Flow Control, Inc., Fort Worth, TX (US)

(21) Appl. No.: 13/848,426

(22) Filed: Mar. 21, 2013

Related U.S. Application Data
(60) Provisional application No. 61/613,849, filed on Mar. 21, 2012.

(51) Int. Cl. F16L 55/00

(52) U.S. Cl. CPC F16L 55/005
USPC 137/15.08; 137/343

(57) ABSTRACT

Loops may be installed on a high pressure flow line and/or well service flow line to reduce movement of components of the flow line in the event of a rupture and/or substantial dislocation of at least a portion of the flow line. At least one restraining link having at least one flexible loop extends across at least one swivel assembly and is secured to adjoining pipes of the flow line. The at least one restraining link is secured while the swivel assembly is in an angled position. A length of the at least one restraining link is less than a horizontal length of the at least one swivel assembly while in an in-line position, preventing, or substantially preventing, the swivel assembly from moving to, or substantially towards, the in-line position. Also, at least one flexible anchor support tether may be wrapped around a coupling between tubular components of the flow line so as to create a right connection loop and a left connection loop. Right and left anchor tethers are looped through the connection loops. Opposite end portions of the anchor tethers are connected to well site equipment and/or other suitable securing sites.

### CROSS-REFERENCE TO RELATED APPLICATIONS

This application claims priority to U.S. Provisional Application No. 61/613,849 (Internal Docket HP70-076), entitled, “Method and System For Restraining A Flow Line” filed on Mar. 21, 2012. This U.S. provisional application is incorporated herein by reference in its entirety. In addition, U.S. Pat. No. 6,481,457, in its entirety, is incorporated herein by reference.

### TECHNICAL FIELD

This disclosure relates in general to safety lines attached to flow lines employed in well service operations or other types of applications where safety or restraint lines may be employed. Certain embodiments are directed to methods and/or systems where there is a need to eliminate a need for, or reduce the need for, tubular crossover anchors.

### BACKGROUND OF THE DISCLOSURE

In oil and gas wells, it is often necessary to stimulate the well in order to increase its production. One method is to fracture the producing formation by introducing fluids into the well under high pressure. The high pressure fluids create cracks or fissures in the formation, causing the oil or gas to flow more freely from the formation. There are other high pressure applications as well.

The flow lines used for these operations, typically, must be able to substantially withstand the high pressure of the fracturing fluids that are pumped into the well. The flow lines are usually only temporarily connected to the wellhead for the duration of the fracturing operation. Even though the flow lines are designed to withstand high pressures, ruptures in the tubular components and couplings may still occur. A rupture can result in uncontrolled flailing or whipping of the flow line components as the high pressure fluid escapes, particularly if the fluid is gaseous.

Certain restraining methods are known in the art. For example, crossover anchors are employed to anchor components of the flow line. A crossover anchor is typically provided by a safety restraint installation company and is not usually owned by the well service company. A crossover anchor is a short tubular member that is secured between conventional length pipes of the flow line and includes metal loops mounted on the exterior of the short tubular member. Flexible loops or anchor lines are looped through the metal loops and secured to well site equipment.

Sometimes tubular crossover anchors cannot be connected into the flow lines or the use of them is limited. The flow lines may have been supplied and connected by a well service type of company, while the safety restraints are being provided and installed by another company. The operator of the well site may prevent the safety restraint company's tubular crossover anchors being connected into the flow line equipment provided by another. Some well service companies have mandated that flow lines cannot contain flow control components such as anchor crossovers with mixed ownership. There is a need in the art for methods and/or systems where there is a need to eliminate a need for, or reduce the need for, tubular crossover anchors. The present disclosure is directed to overcome and/or ameliorate at least one or more of the disadvantages of the prior art, as will become apparent from the discussion herein. The present disclosure also provides other advantages and/or improvements as discussed herein.

### SUMMARY OF THE INVENTION

Certain embodiments are directed to methods of and/or systems for restraining movement of tubular components of a well service flow line in the event of a rupture are described. In certain applications, one or more components of the flow line may be secured to at least one other component by couplings.

Certain embodiments are directed to methods of and/or systems for restraining movement of components of a high pressure flow line in the event of a rupture or substantial disruption of the flow line or a portion of the flow line. The present disclosure is directed to a number of embodiments that disclose different ways that a flow line, or a portion of a flow line, may be restrained to reduce or substantially prevent unwanted movement of the flow line during rupture, or some other dislocation of the flow line or one or more portions of the flow line. The present disclosure contemplates combinations of the disclosed restraining methods and/or systems with other disclosed restraining methods and/or systems. In a particular flow line, different disclosed restraining methods and/or systems may be used on different portions of the same flow line. The restraining method or system used for one portion of a flow line may be the same or different then the restraining methods and/or systems used on a different portion of the flow line.

In certain embodiments, the flow line includes at least one swivel assembly secured between first and second pipes of the flow line by first and second couplings, respectively. The at least one swivel assembly has portions that are movable from an in-line position relative to the first and second pipes to a plurality of angled positions relative to the first and second pipes. The method includes securing opposite ends of a restraining link between the first and second pipes, creating a first fixed end of the restraining link at the first pipe that is substantially immoveable or immoveable toward the second pipe and creating a second fixed end of the restraining link at the second pipe that is substantially immoveable or immoveable toward the first pipe. A length of the restraining link from the first fixed end to the second fixed end is less than a horizontal length of the at least one swivel assembly while in the in-line position, so as to prevent, or substantially prevent, the at least one swivel assembly from moving from the selected angled position to the in-line position. The restraining link prevents, or substantially prevents, the movement of the swivel during a rupture event and avoids, or substantially reduces, the need for crossover anchors to be connected between the at least one swivel assembly and the first and second pipes. Systems using the methods disclosed herein are also disclosed. The systems and/or methods disclosed herein for restraining high pressure flow lines may be used on a portion of the flow line, a substantial portion of the flow line or the entire flow line.

In certain embodiments, the restraining link consists of first and second flexible and loops. These loops may be continuous and/or other suitable structures. The method includes looping a portion of the first loop around the first pipe to create the first fixed end. A portion of the second loop is looped around the second pipe to create the second fixed end. A fastener secures the free end portions of the first and second loops to each other. In certain applications, the restraining link may consist of a first and a second flexible portion. The flexible portions may be continuous, substantially continuous, discontinuous or combinations thereof. The method may include looping a portion of the first flexible portion substantially around the first pipe to create the first fixed end. A flexible portion of the second loop is substantially looped around the second pipe to create the second fixed end. A fastener may be used to secure the free end portions of the first and second loops to each other and/or some other suitable securing point.

In certain embodiments, the restraining link is a single continuous loop. The second fixed end is formed by looping a portion of the single continuous loop around the second pipe and securing that portion to the second pipe with a fastener. In certain applications, the at least one restraining link may be one or more of the following: a single continuous loop, a single loop, at least one continuous loop, at least one loop, at least one loop that is substantially continuous, and other suitable structures.

In certain embodiments, the fastener is a shackle having a pair of legs with free ends that are joined by a movable pin. In certain embodiments, the fastener is a shackle like structure having at least two of leg like structures with portions that may be joined with a joining structure.

In certain embodiments, the first and second couplings circumscribe larger outer diameters than the first and second pipes. The first and second fixed ends are in substantial abutment with the first and second couplings to prevent sliding, or substantially sliding, movement of the first and second fixed ends in the event the at least one swivel assembly tends to move toward the in-line position.

In certain embodiments, the first and second couplings are more closely spaced to each other while the swivel assembly is in the selected angled position than while the swivel assembly is in the in-line position.

In certain embodiments, the at least one swivel assembly has a first vertical section containing a first swivel and connected to the first pipe, enabling the first pipe to rotate in a horizontal plane relative to the second pipe. It also has a second vertical section containing a second swivel and connected to the second pipe, enabling the second pipe to rotate in a horizontal plane relative to the first pipe. In certain applications, one or the other of the sections may be able to rotate in a horizontal plane relative to the pipe but not both.

In certain embodiments, a rib tether is wrapped around a tubular portion of the swivel assembly, the rib tether being a flexible loop. In certain applications the loop may be continuous. A spine tether assembly extends through the rib tether and along a length of the flow line and has opposite ends secured to well site equipment and/or other suitable securing sites.

In certain embodiments, the flow line has tubular components secured together by an anchor coupling. A flexible anchor support tether is wrapped around the anchor coupling so as to create a right connection loop and a left connection loop, with a portion of the anchor support tether wrapped around one of the tubular components. In certain applications the flexible anchor support tether may be continuous. Right and left anchor tethers have end portions looped through the right connection loop and through the left connection loop, respectively. Opposite end portions of the right and the left anchor tethers are connected to well site equipment or other suitable securing sites. In certain applications, the right and left anchor tethers may both be a flexible continuous loop or one may be a flexible continuous loop, a substantially continuous loop or other suitable securing structures.

In certain embodiments, a flow line has at least one swivel assembly connected between first and second pipes with first and second couplings, respectively. The at least one swivel assembly has portions that are movable from a plurality of angled positions relative to the first and second pipes to an in-line position co-axial with the first and second pipes. The swivel assembly has a greater horizontal length while in the in-line position than in one or more of the angled positions. A restraining link having at least one flexible loop is employed. In certain applications the loop may be continuous. A portion of the loop is wrapped, or substantially wrapped, around the first pipe, creating a first fixed end of the restraining link that is immovable, or substantially immovable, toward to the second pipe. With a fastener, another portion of the loop is secured to the second pipe while the swivel assembly is in a selected one of the angled positions, creating a second fixed end of the restraining link that is immovable, or substantially immovable, toward the first pipe. A length of the restraining link from the first end to the second fixed end is less than the horizontal length of the swivel assembly while in the in-line position, so as to prevent, or substantially prevent, the at least one swivel assembly from moving from the selected angled position to the in-line position. A flexible anchor support tether is wrapped around an anchor coupling between second and third pipes of the flow line that are spaced from the at least one swivel assembly so as to create a right connection loop and a left connection loop. In certain applications, the flexible anchor may be continuous. A portion of the anchor support tether is wrapped around one or more of second and third pipes. Right and left anchor tethers having a flexible loop are utilized. An end portion of the right anchor tether is looped through the right connection loop and an end portion of the left anchor tether is looped through the left connection loop. Opposite end portions of the right and the left anchor tethers are connected to well site equipment and/or other suitable securing sites. Rib tethers are wrapped around the first and second couplings and around the third and fourth pipes, one or more of the rib tethers being a flexible loop. In certain applications the rib tethers may be continuous. A spine tether assembly extends through the rib tethers along a length of the flow line. In certain applications, one or more spine tethers may also be used and the one or more spine tethers may passed through one or more of the following: each loop provided by the rib tethers, a portions of the loops provided by the rib tethers, one or more loops provided by the rib tethers and a substantial portion of the loops provided by the rib tethers.

Opposite ends of the spine assembly are secured to well site equipment and/or other suitable securing sites. The engagement of the tethers as described avoids a need, or substantially avoids a need, for tubular crossover anchors being connected into the flow line.

In certain embodiments, the flexible loop of the restraining link consists of first and second loops. In certain applications, one or more of the loops may be continuous. The first loop is wrapped around the first pipe, and the second loop is wrapped around the second pipe. A fastener secures free end portions of the first and second loops to each other. In certain applications, the free end portions of the first and/or second loops may be secured to one or more of the following: each other, another loop and another suitable securing structure.

In certain embodiments, the flexible continuous loop of the restraining link is a single continuous loop. The second fixed end is formed by looping a portion of the single continuous loop over the second pipe and securing said portion to the second pipe with the fastener.

In certain embodiments, the at least one swivel assembly has a first vertical section containing a first swivel and connected to the first coupling, enabling the first pipe to rotate in a horizontal plane relative to the second pipe. It also has a second vertical section containing a second swivel and connected to the second coupling, enabling the second pipe to rotate in a horizontal plane relative to the first pipe.

In certain embodiments, the methods and/or systems include wrapping a flexible anchor support tether around a coupling between first and second tubular components of the flow line so as to create a right connection loop and a left connection loop, with a portion of the anchor tether wrapped around each of first and second components. In certain applications, the flexible anchor support tether may be continuous. Right and left anchor tethers, each being a flexible continuous member, are used. The methods and/or systems include looping an end portion of the right anchor tether through the right connection loop and looping an end portion of the left anchor tether through the left connection loop. Opposite end portions of the right and the left anchor tethers are connected to well site equipment and/or other suitable securing structures.

Anchoring tubular components according to these methods eliminates a need for, or substantially reduces the need for, connecting crossover anchors into the flow line.

In certain embodiments, rib tethers are wrapped around the upstream and the downstream components spaced from the anchor support tether along lengths of the first and second components. Each of the rib tethers is a continuous flexible member wrapped so as to define a rib loop. In certain applications, one or more of the rib tethers is a flexible member wrapped so as to define a rib loop. A spine tether assembly extends through the rib loop of each rib tether and through one of the connection loops of the anchor support tether along a length of the flow line. In certain applications one or more spine tether assemblies may extend through the rib loop of one or more rib tethers, a portion of the rib tethers, a substantial portion of the rib tethers or combinations thereof. Opposite end portions of the spine assembly are secured to well site equipment and/or other suitable securing structures.

In certain embodiments, wrapping the rib tethers is performed so as to provide only a single rib loop for each of the rib tethers. In certain embodiments, wrapping the rib tethers may be performed so as to provide one or more rib loops for each of the rib tethers or one or more of the rib tethers.

Certain embodiments provide safety restraint systems for restraining the movement of a high pressure flow line and/or a well service flow line in the event of rupture and/or substantial disruption of the flow line. The systems disclosed herein may be used on one or more of the following: a portion of the flow line, a substantial portion of the flow line and the entire flow line. The flow line including at least one swivel assembly secured between first and second pipes of the flow line by first and second couplings, respectively, the swivel having portions that are movable from an in-line position relative to the first and second pipes to a plurality of angled positions relative to the first and second pipes, including at least one restraining link between the first and second pipes including a first fixed end linked at the first pipe and a second fixed end linked at the second pipe. The length of the at least one restraining link from the first fixed end to the second fixed end is less than the horizontal length of the at least one swivel assembly while in the in-line position, so as to prevent, or substantially prevent, the at least one swivel assembly from moving from the selected angled position to, or substantially towards, the in-line position. The at least one restraining link prevents, or substantially prevents, the movement of the swivel assembly during a rupture event and avoids the need for crossover anchors to be connected between the swivel assembly and the first and second pipes. In certain applications, if desired, crossover anchors and/or other suitable anchors may be used.

In certain embodiments, the first fixed end is immovable, or substantially immovable, toward the second pipe and the second fixed end is immovable, or substantially immovable, toward the first pipe.

In certain embodiments, the restraining link includes first and second flexible and continuous loops.

In certain embodiments, the first fixed end is a portion of the first loop around the first pipe and the second fixed end is a portion of the second loop around the second pipe.

In certain embodiments, at least one fastener secures the free end portions of the first and second loops.

In certain embodiments, the fastener comprises a shackle having a pair of legs with free ends that are joined by a movable pin.

In other certain embodiments, the at least one restraining link includes a single continuous loop; and the second fixed end is formed by looping a portion of the single continuous loop around the second pipe and securing said portion to the second pipe with at least one fastener.

In certain embodiments, the first and second couplings circumscribe larger outer diameters than the first and second pipes; and the first and second fixed ends are in substantial abutment with the first and second couplings to prevent, or substantially prevent, sliding movement of the first and second fixed ends in the event the swivel assembly tends to substantially move toward the in-line position.

In certain embodiments, at least one rib tether is provided and wrapped around a tubular portion of the at least one swivel assembly, the at least one rib tether being a continuous flexible loop, and a spine tether assembly is provided that extends through the rib tether and along a length of the flow line. In certain embodiments, at least one rib tether is provided and wrapped around a tubular portion of the at least one swivel assembly, the at least one rib tether being a loop, and at least one spine tether assembly is provided that extends through one or more of the rib tethers and along a length of the flow line or some portion of the flow line length.

In other certain embodiments, the opposite ends of the spine tether assembly are secured to well site equipment and/or other suitable securing structures.

Other aspects, features, and advantages will become apparent from the following detailed description when taken in conjunction with the accompanying drawings, which are a part of this disclosure and which illustrate, by way of example, the embodiments disclosed herein.

### DESCRIPTION OF THE FIGURES

The accompanying drawings facilitate an understanding of the various embodiments.

FIG. 1 is an exemplary perspective view of a double swivel assembly connected into a flow line prior to installing restraints.

FIG. 2 is a perspective view of the double swivel assembly of FIG. 1 with safety restraints installed in accordance with certain embodiments.

FIG. 3 is a top schematic view of the double swivel assembly of FIG. 1 with anchor tethers installed in accordance with certain embodiments.

FIG. 4 is a top schematic view of the double swivel assembly of FIG. 1 without anchor tethers installed and moved to an in-line position.

FIG. 5 is a top view of a flow line having anchor lines secured to an anchor support in accordance with certain embodiments.

FIG. 6 is a perspective view of a first step in wrapping the anchor support of FIG. 4 around a flow line in accordance with certain embodiments.

FIG. 7 is a perspective view of a second step in wrapping the anchor support of FIG. 4 around a flow line in accordance with certain embodiments.

FIG. 8 is a perspective view of the completion of the second step in wrapping the anchor support of FIG. 4 around a flow line in accordance with certain embodiments.

FIG. 9A is a perspective view of a double swivel assembly with a safety restraint installed in accordance with certain embodiments.

FIG. 9B is a perspective view of a double swivel assembly with a safety restraint installed in accordance with certain embodiments.

FIG. 10 is a top schematic view of the double swivel assembly of FIG. 9.

### DETAILED DESCRIPTION

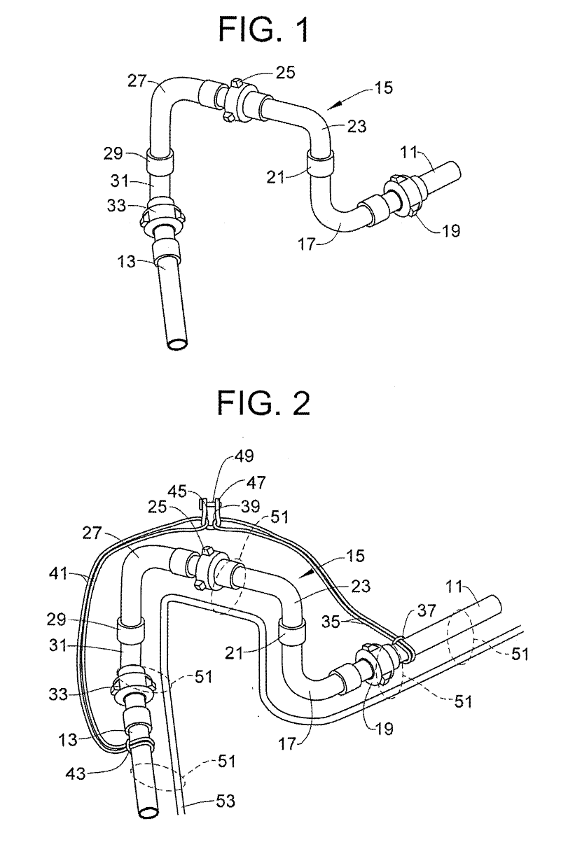

Referring to FIG. 1, the well service flow line has an upstream pipe or component 11 and a downstream component or pipe 13. The terms “upstream” and “downstream” are used arbitrarily and refer to a direction of fluid flow when a pumping truck is pumping into a wellhead. During certain parts of a well service operation, the fluid may flow in an opposite direction. The upstream or first pipe 11 and the downstream or second pipe 13 are connected to each other via an intermediate component. In this example, the intermediate component comprises a double swivel assembly 15. Alternately, the intermediate component may be a triple or more swivel assemblies or other flow line components. FIG. 1 is an exemplary configuration and other configurations of well service flow lines and/or high pressure flow lines may also be restrained using one or more of the embodiments and/or combinations of the embodiments disclosed herein.

The swivel assembly 15 has an upstream elbow 17 that has a horizontal portion that connects to upstream pipe 11 with an upstream coupling 19. The upstream coupling 19 may be a union connector, a clamp connector, or other types of suitable connectors. The upstream coupling 19 is illustrated as being a union type coupling with hammer lugs that circumscribe an outer diameter greater than an outer diameter of the upstream pipe 11. The elbow 17 has an upright or vertical portion that contains a swivel element 21 containing seals and bearings. Another elbow 23 extends upward from the swivel 21 and extends horizontally over to an intermediate coupling 25. The intermediate coupling 25 may be the same type or similar type as the upstream coupling 19.

A third elbow 27 has a horizontal portion connected to the intermediate coupling 25. The elbow 27 has a vertical portion extending downward to a second swivel 29, which may be the same structure, or similar structure, as the swivel 21. An elbow 31 has a vertical portion joining the swivel 29 and a horizontal portion secured to the downstream pipe 13 via a downstream coupling 33. The swivel 21 allows the upstream pipe 11 to rotate in a horizontal plane to a desired orientation relative to the intermediate coupling 25. Stated another way, the intermediate coupling 25 can be rotated about an axis of the swivel 21 so that the upper horizontal portion of the elbow 23 points in a selected angle relative to the upstream pipe 11. The upper horizontal portion of the elbow 27 typically is co-axial with the upper horizontal portion of the elbow 23. Similarly, the swivel 29 allows the lower horizontal portion of the elbow 31 and the downstream pipe 13 to be rotated to a selected angle relative to the upper horizontal portions of the elbows 27 and 23.

Referring to FIG. 2, a method, according to certain embodiments, of restraining movement of the upstream and downstream pipes 11, 13 in the event of a rupture and/or substantial dislocation of at least a portion of the flow line is illustrated. FIG. 2 also illustrates systems according to certain embodiments. A restraint link includes an upstream tether or line 35, which is a continuous or endless loop of strong flexible material. The tether illustrated in FIG. 2 is continuous, however, in certain applications, the tether may be continuous, substantially continuous, discontinuous, substantially discontinuous or combinations thereof. The material may comprise longitudinally extending filaments within a woven outer covering. Other suitable constructions or configurations of the material may also be used in certain applications. Upstream tether 35 does not have any ends because it is continuous, however, for convenience, the term “end” or “end portion” is used when the tether 35 is pulled into an elongated configuration. As shown in FIG. 2, an end portion 37 is wrapped or looped around the upstream pipe 11 to secure it to the upstream pipe 11. This end portion, which may be referred to as a fixed end 37 once secured, is closely spaced or even touching portions of the upstream side of the upstream coupling 19. The fixed end 37 cannot substantially slide toward the second pipe 13 because of its abutment with the upstream coupling 19. A free end 39 of the upstream tether 35 is brought toward the downstream pipe 13.

The restraint link also includes a downstream tether or line 41 and similarly has a fixed end 43 looped around the downstream pipe 13 next to the downstream side of the downstream coupling 33. The downstream tether 41 is preferably the same type as the upstream tether 35 but it need not have the same elongated length. In certain applications, the upstream and downstream tethers may be made of different materials. The downstream tether 41 has a free end 45, when elongated, that is brought into close proximity or contact with the free end 39 of the upstream tether 35. Since both of the free ends 39, 45 are loops, they cannot be looped together to secure the tethers 35, 41 to each other. In this example, they are secured to each other by a fastener that is a shackle 47, which is a strong U-shaped metal member. The fastener can be a metal, composite, or fabric securing device that is capable of withstanding the forces under a rupture event and/or substantial dislocation event. A leg of the shackle 47 passes through the loop of each of the free ends 39, 45; then a pin 49 closes the free ends of the legs of the shackle 47. The pin 49 may be threaded. Other suitable fastening configurations may also be used in certain applications. In addition, one or more of the loops may be secured in some other suitable fashion.

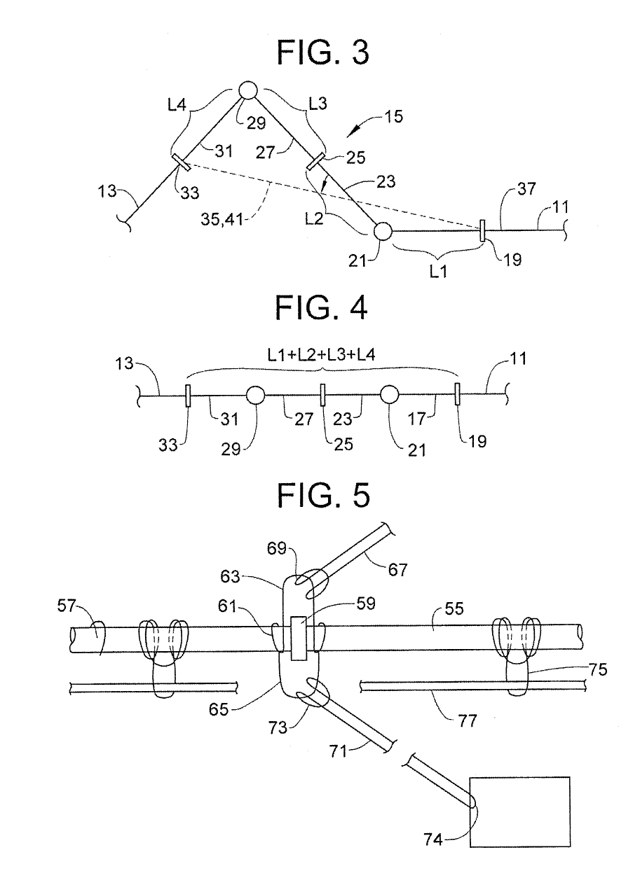

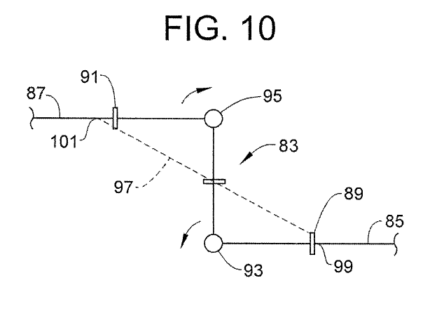

FIG. 3 schematically illustrates a top view of the tethers 35, 41 attached to the swivel assembly 15. During a rupture and/or a substantial dislocation event within the swivel assembly 15, the upstream and downstream pipes 11 would tend to move away from each other to a coaxial position illustrated in FIG. 10. The swivel assembly 15 may tend to move to, or substantially towards, the in-line position as shown in FIG. 4. The swivel 21 would allow the upper horizontal portion of the elbow 23 to rotate counter clockwise, as indicated by the arrow. The swivel 29 would tend to allow the lower horizontal portion of the elbow 27 to rotate clockwise, as indicated by the arrow. If the downstream pipe 13 coaxially aligns with the upstream pipe 11, or vice versa, the upstream and downstream couplings 19, 33 move apart from each other. The swivels 21, 29 allow anchor assembly 15 to elongate to a greater horizontal length. This movement can be dangerous to any personnel close by.

To limit the movement described, the combined length from the fixed end 37 to the fixed end 43 of the restraint tethers 35, 41, when connected, is selected to be less than the overall horizontal length of the swivel assembly 15. The combined length of the tethers 35, 41 is less than the sum of L1, L2, L3 and L4 of the swivel assembly 15. L1 is the length of the horizontal portion of the elbow 17; L2 is the length of the horizontal portion of the elbow 23; L3 is the length of the horizontal portion of the elbow 27; and L4 is the length of the horizontal portion of the elbow 31. Consequently, when the swivel assembly 15 tries to fold into a straight line coaxial with the upstream and downstream pipes 11, 13, as shown in FIG. 4, the tethers 35, 41 become taut and limit the rotation allowed about the swivels 21, 29. This limit on angular movement also limits the distance the upstream and downstream couplings 19, 33 can move apart from each other.

Referring again to FIG. 2, the methods and/or systems illustrated therein may include adding additional restraints. Rib tethers 51 are wrapped around each coupling on the flow line and also around some of the pipes between the couplings. In certain applications, rib tethers used with the flow line may be wrapped around one or more of the following: each coupling, one or more couplings, a portion of the couplings and a substantial portion of the couplings. The rib tethers 51 are illustrated in FIG. 2 with dotted lines. In this exemplary, each is a continuous flexible loop that is wrapped or looped around the couplings 19, 25 and 33, as well as around the upstream and downstream pipes 11, 13. The rib tethers illustrated in FIG. 2 are continuous, however, in certain applications, the tether may be continuous, substantially continuous, discontinuous, substantially discontinuous or combinations thereof. Each rib tether 51 is secured in a manner described in U.S. Pat. No. 6,481,457, which is incorporated herein by reference in its entirety. However, in certain applications, other ways of sufficiently securing one or more rib tethers may also be used. Also, a spine tether 53 extends along the length of the flow line, passing through the loops provided by the rib tethers 51. The spine tether 53 is also a flexible continuous loop. The spine tether 53 may have its end portions, when elongated, looped with other spine tethers to form one or more selected lengths. One end of the assembly of the spine tethers 53 secures to well site equipment, such as a pumping truck or unit. Another end of the assembly of the spine tethers 53 secures to another piece of well site equipment, such as a manifold trailer or a wellhead. In certain applications, one or more ends of the spin tether may be secured in one or more of the following ways: to well site equipment, another piece of well site equipment, the ground, a ground fixture, one or more other spin tethers and other suitable securing sites.

In certain applications, the spine tether may be continuous, substantially continuous, discontinuous, substantially discontinuous or combinations thereof. In addition, in certain applications, the spine tether may also extend along one or more of the following: a portion of the flow line, a substantial portion of the flow line and the entire flow line. The spine tether may also be passed through one or more of the following: each loop provided by the rib tethers, a portion of the loops provided by the rib tethers, one or more loops provided by the rib tethers and a substantial portion of the loops provided by the rib tethers. In certain applications, at least a portion of the spine tether may be associated with one or more loop tethers in one or more of the following manners: the at least a portion of the spine tether may be passed through one or more loops, the at least a portion of the spine tether may be secured to the one or more loop tethers, the at least a portion of the spine tether may be secured to the one or more loop tethers and not pass through one or more loops and the at least a portion of the spine tether may be associated with the one or more loop tethers in a manner that provided sufficient restraint.

Referring to FIG. 5, in certain embodiments, methods and/or systems of anchoring components of a flow line are illustrated. A first pipe 55 and a second pipe 57 are coupled together by a coupling 59, which may be of the same type, or similar type, as the couplings disclosed herein, but may be referred to as an anchor coupling. The first and second pipes 55, 57 may be connected into the same flow line as the swivel assembly 15 (FIG. 2), but spaced from it. An anchor support tether 61 is wrapped or looped around the coupling 59, with a portion of the tether 61 wrapping around the first pipe 55 and other portion wrapping around the second pipe 57. In this exemplary, the anchor support tether 61 is also a continuous loop and may be the same, or similar, construction and elongated length as rib tethers 51 (FIG. 2). In certain applications, the anchor support tethers and the rib tethers may be of different constructions. When the anchor support tether 61 is looped around the pipes 55, 57, two connection loops are created, one referred to as the right connection loop 63 and the other the left connection loop 65. The connection loops 63, 65 are on opposite sides of the pipes 55, 57. The coupling 59 is in the center of anchor support tether 61.

A right anchor tether 67 has a free end 69 that may be looped through the right connection loop 63 before its fixed end 70 is connected to any well site equipment, such as a pump truck. Then the fixed end 70 may be secured by a shackle or the like to the pump truck. A left anchor tether 71 has a free end 73 that is looped through left connection loop 65 before its fixed end 74 is secured to well site equipment, such as another pump truck or a wellhead.

The methods and/or systems of FIG. 5 may employ additional restraints, including a plurality of rib tethers 75 looped around couplings and other pipes. The rib tethers 75 are looped so as to have a single loop, unlike the anchor support tether 61. The spine tether 77 extends along the flow line and is threaded through the single loops of rib tethers 75. The spine tether 77 may be part of a spine tether assembly with ends looped together. The free ends of the spine tether assembly 77 may be secured to well site equipment.

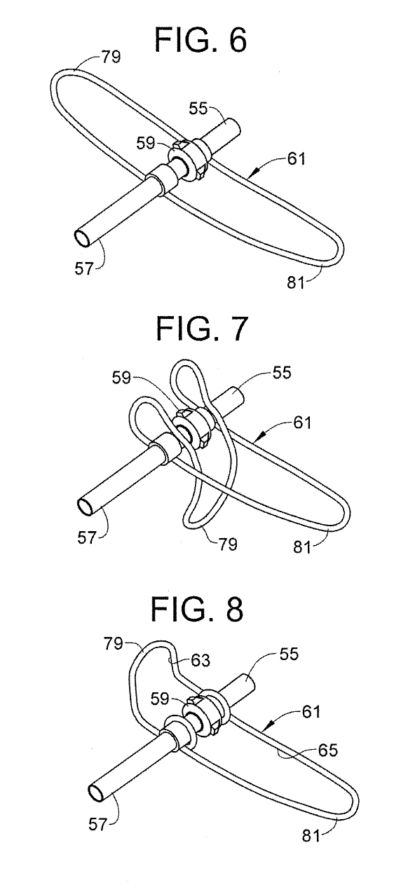

FIGS. 6, 7 and 8 illustrate how the anchor support tether 61 is secured to the pipes 55, 57, according to certain embodiments. As shown in FIG. 6, the support tether 61 is pulled to an elongated form and placed either over the pipes 55, 57 or under as shown. The coupling 59 is centered between opposite portions of support tether 61. The end portions 79, 81 will be on opposite sides of the pipes 55, 57. The operator then inserts the end portion 79 through the loop created by the end portion 81, as illustrated in FIG. 7. As shown in FIG. 8, the single pass of FIG. 7 creates a right connection loop 63 and a left connection loop 65.

To create a rib tether 75 (FIG. 5) or rib tethers 51 (FIG. 2), the operator makes an additional pass of the end portion 79 through the loop created by the end portion 81. The operator then pulls one of the end portions 79, 81 taut, which brings the other end portion 79, 81 into abutment with the coupling 59 and creates a single loop. The anchor system shown in FIG. 4 may be employed in combination with the methods and/or systems of FIGS. 2 and 3, if the flow line contains swivel assemblies. In certain applications, the anchor system shown in FIG. 4 may be employed in combination with the methods and/or systems of other embodiments disclosed herein.

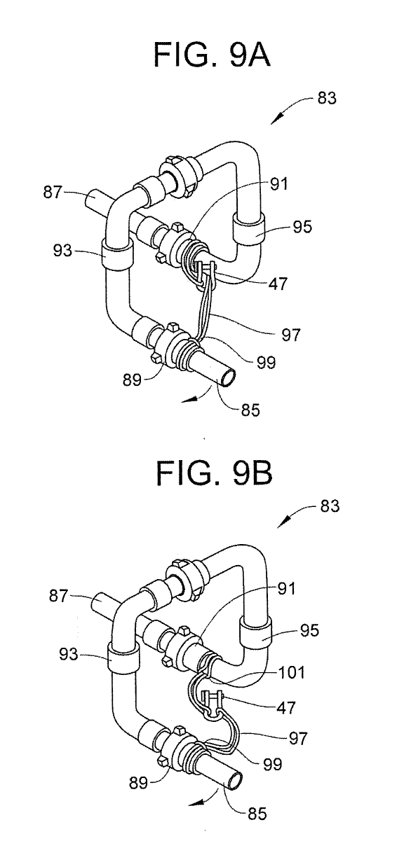

In certain embodiments, as exemplified in FIGS. 9A and 9B, the swivel assembly 83 may be identical, or substantially identical, to the swivel assembly 15 (FIG. 1). In certain applications, the swivel assemblies used may be identical, similar, different or combinations thereof. The swivel assembly 83 is secured between a first pipe 85 and a second pipe 87 by first and second couplings 89, 91, respectively. The swivel assembly 83 has a first swivel 93 and a second swivel 95 that may be oriented vertically when installed within a flow line. In the position shown, the first and second pipes 85, 87 are parallel, or substantially parallel to each other, but the axis of each of the pipes 85, 87 may be offset from the other. If the components of the swivel assembly 83 are rotated so that the first and second pipes 85, 87 are coaxial, or substantially coaxial, with each other, the distance between the first and second couplings 89, 91 increases over the angled position shown in FIGS. 9A and 9B. FIG. 9B is a perspective view of a double swivel assembly with a safety restraint installed in accordance with certain embodiments. In this embodiment, additional portions of the safety restraint are incorporated within the fastener legs below the pin 49. In this exemplary, the faster is a shackle 47, however, other fastener structures may also be used. FIG. 9A is a perspective view of a double swivel assembly with a safety restraint installed in accordance with certain embodiments. This embodiment, shows the safety restraint loops secured or tied to each other via a shackle 49.

A restraint link shown in FIG. 10 prevents, or substantially prevents, the swivel assembly 83 from moving to, or substantially towards, an in-line position. In certain embodiments, the restraint link includes a tether 97 that is a continuous loop and may be identical to the other tethers described. In certain applications, the restraint link may be one or more of the following: The tether 97 has a first fixed end 99 that is looped around the first pipe 85 on a side of the first coupling 89 that is opposite the swivel assembly 83. Another end portion of the tether 97 is wrapped around the second pipe 87. Since the other end portion is part of a loop, it cannot pass through itself to secure the tether 97 to the second pipe 87. Instead, the second fixed end 101 is created by inserting a shackle through the looped portions of the tether 97 after wrapping around the second pipe 87. The second fixed end 101 is located on a side of the second coupling 91 opposite the swivel assembly 83. FIG. 10 illustrates how the tether 97 prevents rotation, or substantially prevents rotation, of the swivels 95, 97 to, or substantially towards, an in-line position with the pipes 85, 87.

The foregoing embodiment(s) provide several operational advantages aimed at safely restraining flow lines without the need for crossover anchors. Certain embodiments provide methods and/or systems of retraining flow lines during a rupture event and/or substantial dislocation events that prevents, or substantially prevents, at least one swivel assembly from moving from a predetermined position to, or substantially towards, an in-line position without the need for crossover anchor placed between the flow lines.

Other exemplary non-limiting embodiments include the following.

### Example 1

A method of substantially restraining movement of at least a portion of a high pressure flow line in the event of a rupture and/or substantial dislocation of at least a portion of the flow line, the flow line including at least one swivel assembly secured between first and second pipes of the flow line by first and second couplings, respectively, the at least one swivel assembly having portions that are movable from an in-line position relative to the first and second pipes to a plurality of angled positions relative to the first and second pipes, the method comprising: securing opposite ends of at least one restraining link between the first and second pipes, creating a first fixed end of the at least one restraining link at the first pipe that is substantially immoveable toward the second pipe and creating a second fixed end of the at least one restraining link at the second pipe that is substantially immoveable toward the first pipe; wherein a length of the at least one restraining link from the first fixed end to the second fixed end is less than a horizontal length of the at least one swivel assembly while in the in-line position, so as to substantially prevent the swivel assembly from moving from the selected angled position substantially towards the in-line position.

### Example 2

The method according to example 1, wherein the at least one restraining link comprises first and second flexible loops, and the method further comprises: looping a portion of the first loop around the first pipe to create the first fixed end; looping a portion of the second loop around the second pipe to create the second fixed end; and securing free end portions of the first and second loop to each other with a fastener and/or to another securing site.

### Example 3

The method according to one or more examples, wherein: the at least one restraining link comprises a single loop; and the second fixed end is formed by looping a portion of the single loop around the second pipe and securing the portion to the second pipe with the fastener.

### Example 4

The method according to one or more examples, wherein the fastener comprises a shackle having two or more legs with end portions that are joined by a pin.

### Example 5

The method according to one or more examples, wherein: the first and second couplings circumscribe larger outer diameters than the first and second pipes; and the first and second fixed ends are in substantial abutment with the first and second couplings to substantially prevent sliding movement of the first and second fixed ends in the event the at least one swivel assembly tends to move toward the in-line position.

### Example 6

The method according to one or more examples, wherein: the first and second couplings are more closely spaced to each other while the swivel assembly is in the selected angled position than while the swivel assembly is in the in-line position.

### Example 7

The method according to one or more examples, wherein the at least one swivel assembly comprises: a first vertical section containing a first swivel and connected to the first pipe, enabling the first pipe to rotate in a horizontal plane relative to the second pipe; and a second vertical section containing a second swivel and connected to the second pipe, enabling the second pipe to rotate in a horizontal plane relative to the first pipe.

### Example 8

The method according to one or more examples, further comprising: wrapping at least one rib tether around a tubular portion of the at least one swivel assembly, the at least one rib tether being a flexible loop; and extending at least one spine tether assembly through the at least one rib tether and along a length of the flow line.

### Example 9

The method according to one or more examples, wherein the flow line has tubular components secured together by at least one anchor coupling and wherein the method further comprises: wrapping at least one flexible anchor support tether around the at least one anchor coupling so as to create a right connection loop and a left connection loop, with a portion of the at least one anchor support tether wrapped around one or more of the tubular components; providing right and left anchor tethers, looping an end portion of the right anchor tether through the right connection loop and looping an end portion of the left anchor tether through the left connection loop; and connecting opposite end portions of the right and/or the left anchor tethers to well site equipment and/or other securing sites.

### Example 10

A method of restraining movement of at least a portion of a high pressure flow line in the event of a rupture and/or substantial dislocation of at least a portion of the flow line, the flow line having a at least one swivel assembly connected between first and second pipes with first and second couplings, respectively, the at least one swivel assembly having portions that are movable from a plurality of angled positions relative to the first and second pipes to an in-line position co-axial with the first and second pipes, the at least one swivel assembly having a greater horizontal length while in the in-line position than in the plurality of the angled positions, the method comprising: providing at least one restraining link comprising at least one flexible loop; wrapping a portion of the loop around the first pipe to create a first fixed end of the at least one restraining link that is substantially immovable toward the second pipe; securing another portion of the loop to the second pipe while the at least one swivel assembly is in a selected one of the angled positions with at least one fastener to create a second fixed end of the at least one restraining link that is substantially immovable toward the first pipe; wherein a length of the at least one restraining link from the first end to the second fixed end is less than the horizontal length of the swivel assembly while in the in-line position, so as to substantially prevent the swivel assembly from moving from the selected angled position substantially towards to the in-line position; wrapping a at least one flexible anchor support tether around at least one anchor coupling between second and third pipes of the flow line that are spaced from the at least one swivel assembly so as to create a right connection loop and a left connection loop, with a portion of the anchor support tether wrapped around one or more of second and third pipes; providing right and left anchor tethers, looping an end portion of the right anchor tether through the right connection loop and looping an end portion of the left anchor tether through the left connection loop; connecting opposite end portions of the right and/or the left anchor tethers to well site equipment and/or other securing sites; wrapping at least one rib tether around the first and second couplings and around the third and fourth pipes, one or more of the rib tethers being a continuous flexible loop; and extending at least one spine tether assembly through the at least one rib tether along a length of the flow line.

### Example 11

The method according to example 10, wherein: the at least one flexible loop of the at least one restraining link comprises first and second loops: the first loop is wrapped around the first pipe; the second loop is wrapped around the second pipe; and the at least one fastener secures free end portions of the first and second loops to each other and/or some other securing site.

### Example 12

The method according to one or more examples, wherein: the at least one flexible loop of the at least one restraining link comprises a single loop; and the second fixed end is formed by looping a portion of the single loop over the second pipe and securing the portion to the second pipe with the fastener.

### Example 13

The method according to one or more examples, wherein the at least one swivel assembly comprises: a first vertical section containing a first swivel and connected to the first coupling, enabling the first pipe to rotate in a horizontal plane relative to the second pipe; and a second vertical section containing a second swivel and connected to the second coupling, enabling the second pipe to rotate in a horizontal plane relative to the first pipe.

### Example 14

A method of restraining movement of at least a portion of a high pressure flow line in the event of a rupture and/or substantial dislocation of at least a portion of the flow line, comprising: wrapping at least one flexible anchor support tether around a coupling between a first and a second tubular component of the flow line so as to create a right connection loop and a left connection loop, with a portion of the at least one anchor tether wrapped around a portion of the first tubular component and a portion of the second component; providing right and left anchor tethers, looping an end portion of the right anchor tether through the right connection loop and looping an end portion of the left anchor tether through the left connection loop; and connecting opposite end portions of the right and the left anchor tethers to well site equipment and/or some other securing site.

### Example 15

The method according to one or more examples, further comprising: wrapping at least one rib tether around the upstream and the downstream components spaced from the anchor support tether along lengths of the first and second components, one or more of the rib tethers being a flexible member wrapped so as to define at least one rib loop; and extending at least one spine tether assembly through the at least one rib loop of one or more of the rib tethers and through one of the connection loops of the anchor support tether along a length of the flow line.

### Example 16

The method according to one or more examples, wherein wrapping of the one or more rib tethers is performed so as to provide only a single rib loop for one or more of the rib tethers.

### Example 17

A safety restraint system for restraining the movement of at least a portion of a high pressure flow line in the event of rupture and/or substantial dislocation of at least a portion of the flow line, the flow line including at least one swivel assembly secured between first and second pipes of the flow line by first and second couplings, respectively, the at least one swivel assembly having portions that are movable from an in-line position relative to the first and second pipes to a plurality of angled positions relative to the first and second pipes, comprising: at least one restraining link between the first and second pipes including a first fixed end linked at the first pipe and a second fixed end linked at the second pipe; wherein the length of the at least one restraining link from the first fixed end to the second fixed end is less than the horizontal length of the at least one swivel assembly while in the in-line position, so as to substantially prevent the at least one swivel assembly from moving from the selected angled position substantially towards the in-line position.

### Example 18

The system of one or more examples, wherein the first fixed end is substantially immovable toward the second pipe and the second fixed end is substantially immovable toward the first pipe.

### Example 19

The system of one or more example 17, wherein the at least one restraining link comprises first and second flexible loops.

### Example 20

The system of one or more examples, wherein the first fixed end is a portion of the first loop around the first pipe and the second fixed ends is a portion of the second loop around the second pipe.

### Example 21

The system of one or more examples, further comprising at least one fastener to secure the free end portions of the first and second loops.

### Example 22

The system of one or more examples, wherein the at least one fastener comprises a shackle having two or more legs with end portions that are joined by a pin.

### Example 23

The system of one or more examples, wherein the at least one restraining link comprises a single loop; and the second fixed end is formed by looping a portion of the single loop around the second pipe and securing said portion to the second pipe with at least one fastener.

### Example 24

The system of one or more examples, wherein: the first and second couplings circumscribe larger outer diameters than the first and second pipes; and the first and second fixed ends are in substantial abutment with the first and second couplings to substantially prevent sliding movement of the first and second fixed ends in the event the swivel assembly tends to move toward the in-line position.

### Example 25

The system of one or more examples, further comprising at least one rib tether wrapped around a tubular portion of the at least one swivel assembly, the at least one rib tether being a flexible loop, and a spine tether assembly that extends through the at least one rib tether and along a length of the flow line.

### Example 26

The system of one or more examples, wherein the opposite ends of the spine tether assembly are secured.

### Example 27

A safety restraint system for restraining the movement of at least a portion of a high pressure flow line in the event of rupture and/or substantial dislocation of at least a portion of the flow line, the flow line including at least one swivel assembly secured between first and second pipes of the flow line by first and second couplings, respectively, the at least one swivel assembly having portions that are movable from an in-line position relative to the first and second pipes to a plurality of angled positions relative to the first and second pipes, comprising: at least restraining means between the first and second pipes including a first fixed end linked at the first pipe and a second fixed end linked at the second pipe; wherein the length of the at least one restraining means from the first fixed end to the second fixed end is less than the horizontal length of the at least one swivel assembly while in the in-line position, so as to substantially prevent the at least one swivel assembly from moving from the selected angled position substantially towards the in-line position.

### Example 28

The system of one or more examples, further comprising at least one fastener means to secure the free end portions of the first and second loops.

### Example 27

The method according to one or more examples, wherein the high pressure flow line is a well service flow line.

### Example 28

The system of one or more examples, wherein the high pressure flow line is a well service flow line.

### Example 29

The method according to one or more examples, wherein the event is a rupture.

### Example 30

The system of one or more examples, wherein the event is a rupture.

### Example 31

The method according to one or more examples, wherein the at least one restraining link comprises first and second flexible loops that are continuous.

### Example 32

The system of one or more examples, wherein the at least one restraining link comprises first and second flexible loops that are continuous.

### Example 33

The method according to one or more examples, wherein the at least one rib tether is a continuous flexible loop.

### Example 34

The system of one or more examples, wherein the at least one rib tether is a continuous flexible loop.

### Example 35

The method according to one or more examples, wherein opposite ends of the spine assembly are secured to well site equipment.

### Example 36

The system of one or more examples, wherein opposite ends of the spine assembly are secured to well site equipment.

### Example 37

The method according to one or more examples, wherein at least one flexible anchor is continuous.

### Example 38

The system of one or more examples, wherein at least one flexible anchor is continuous.

In the foregoing description of certain embodiments, specific terminology has been resorted to for the sake of clarity. However, the disclosure is not intended to be limited to the specific terms so selected, and it is to be understood that specific terms include other technical equivalents which operate in a similar manner to accomplish a similar technical purpose. Terms such as “left” and right“, “front” and “rear”, “above” and “below” and the like are used as words of convenience to provide reference points and are not to be construed as limiting terms.

In this specification, the word “comprising” is to be understood in its “open” sense, that is, in the sense of “including”, and thus not limited to its “closed” sense, that is the sense of “consisting only of”. A corresponding meaning is to be attributed to the corresponding words “comprise”, “comprised” and “comprises” where they appear.

In addition, the foregoing describes only some embodiments of the invention(s), and alterations, modifications, additions and/or changes can be made thereto without departing from the scope and spirit of the disclosed embodiments, the embodiments being illustrative and not restrictive.

Furthermore, invention(s) have described in connection with what are presently considered to be the most practical and preferred embodiments, it is to be understood that the invention is not to be limited to the disclosed embodiments, but on the contrary, is intended to cover various modifications and equivalent arrangements included within the spirit and scope of the invention(s). Also, the various embodiments described above may be implemented in conjunction with other embodiments, e.g., aspects of one embodiment may be combined with aspects of another embodiment to realize yet other embodiments. Further, each independent feature or component of any given assembly may constitute an additional embodiment.

What is claimed is:

1. A method of substantially restraining movement of at least a portion of a high pressure flow line in the event of a rupture and/or substantial dislocation of at least a portion of the flow line, the flow line including at least one swivel assembly secured between first and second pipes of the flow line by first and second couplings, respectively, the at least one swivel assembly having portions that are movable from an in-line position relative to the first and second pipes to a plurality of angled positions relative to the first and second pipes, the method comprising:
securing opposite ends of at least one restraining link between the first and second pipes, creating a first fixed end of the at least one restraining link at the first pipe that is substantially immoveable toward the second pipe and creating a second fixed end of the at least one restraining link at the second pipe that is substantially immoveable toward the first pipe;
wherein a length of the at least one restraining link from the first fixed end to the second fixed end is less than a horizontal length of the at least one swivel assembly while in the in-line position, so as to substantially prevent the swivel assembly from moving from the selected angled position substantially towards the in-line position.

2. The method according to claim 1, wherein the at least one restraining link comprises first and second flexible loops, and the method further comprises:
looping a portion of the first loop around the first pipe to create the first fixed end;
looping a portion of the second loop around the second pipe to create the second fixed end; and
securing free end portions of the first and second loop to each other with a fastener and/or to another securing site.

3. The method according to claim 1, wherein:
the at least one restraining link comprises a single loop; and
the second fixed end is formed by looping a portion of the single loop around the second pipe and securing the portion to the second pipe with the fastener.

4. The method according to claim 1, wherein the fastener comprises a shackle having two or more legs with end portions that are joined by a pin.

5. The method according to claim 4, wherein the fastener comprises a shackle having two or more legs with end portions that are joined by a pin.

6. The method according to claim 1, further comprising:
wrapping at least one rib tether around a tubular portion of the at least one swivel assembly, the at least one rib tether being a flexible loop; and
extending at least one spine tether assembly through the at least one rib tether and along a length of the flow line.

7. The method according to claim 4, further comprising:
wrapping at least one rib tether around a tubular portion of the at least one swivel assembly, the at least one rib tether being a flexible loop; and
extending at least one spine tether assembly through the at least one rib tether and along a length of the flow line.

8. The method according to claim 1, wherein the flow line has tubular components secured together by at least one anchor coupling and wherein the method further comprises:
wrapping at least one flexible anchor support tether around the at least one anchor coupling so as to create a right connection loop and a left connection loop, with a portion of the at least one anchor support tether wrapped around one or more of the tubular components;
providing right and left anchor tethers, looping an end portion of the right anchor tether through the right connection loop and looping an end portion of the left anchor tether through the left connection loop; and
connecting opposite end portions of the right and/or the left anchor tethers to well site equipment and/or other securing sites.

9. The method according to claim 7, wherein the flow line has tubular components secured together by at least one anchor coupling and wherein the method further comprises:
wrapping at least one flexible anchor support tether around the at least one anchor coupling so as to create a right connection loop and a left connection loop, with a portion of the at least one anchor support tether wrapped around one or more of the tubular components;
providing right and left anchor tethers, looping an end portion of the right anchor tether through the right connection loop and looping an end portion of the left anchor tether through the left connection loop; and
connecting opposite end portions of the right and/or the left anchor tethers to well site equipment and/or other securing sites.

10. A method of restraining movement of at least a portion of a high pressure flow line in the event of a rupture and/or substantial dislocation of at least a portion of the flow line, comprising:
wrapping at least one flexible anchor support tether around a coupling between a first and a second tubular component of the flow line so as to create a right connection loop and a left connection loop, with a portion of the at least one anchor tether wrapped around a portion of the first tubular component and a portion of the second component;
providing right and left anchor tethers, looping an end portion of the right anchor tether through the right connection loop and looping an end portion of the left anchor tether through the left connection loop; and
connecting opposite end portions of the right and the left anchor tethers to well site equipment and/or some other securing site.

11. The method according to claims 10, further comprising:
wrapping at least one rib tether around the upstream and the downstream components spaced from the anchor support tether along lengths of the first and second components, one or more of the rib tethers being a flexible member wrapped so as to define at least one rib loop; and
extending at least one spine tether assembly through the at least one rib loop of one or more of the rib tethers and through one of the connection loops of the anchor support tether along a length of the flow line.

12. The method according to claim 11, wherein wrapping of the one or more rib tethers is performed so as to provide only a single rib loop for one or more of the rib tethers.

13. A safety restraint system for restraining the movement of at least a portion of a high pressure flow line in the event of rupture and/or substantial dislocation of at least a portion of the flow line, the flow line including at least one swivel assembly secured between first and second pipes of the flow line by first and second couplings, respectively, the at least one swivel assembly having portions that are movable from an in-line position relative to the first and second pipes to a plurality of angled positions relative to the first and second pipes, comprising:
at least one restraining link between the first and second pipes including a first fixed end linked at the first pipe and a second fixed end linked at the second pipe;
wherein the length of the at least one restraining link from the first fixed end to the second fixed end is less than the horizontal length of the at least one swivel assembly while in the in-line position, so as to substantially prevent the at least one swivel assembly from moving from the selected angled position substantially towards the in-line position.

14. The system of claim 13, wherein the first fixed end is substantially immovable toward the second pipe and the second fixed end is substantially immovable toward the first pipe.

15. The system of claim 14, wherein the at least one restraining link comprises first and second flexible loops.

16. The system of claim 13, wherein the at least one restraining link comprises first and second flexible loops.

17. The system of claim 15, wherein the first fixed end is a portion of the first loop around the first pipe and the second fixed ends is a portion of the second loop around the second pipe.

18. The system of claim 13, wherein the first fixed end is a portion of the first loop around the first pipe and the second fixed ends is a portion of the second loop around the second pipe.

19. The system of claim 17, further comprising at least one fastener to secure the free end portions of the first and second loops.

20. The system of claim 15, further comprising at least one rib tether wrapped around a tubular portion of the at least one swivel assembly, the at least one rib tether being a flexible loop, and a spine tether assembly that extends through the at least one rib tether and along a length of the flow line.
